(19) United States
(12) Patent Application Publication
(10) Pub. No.: US 2009/0173580 A1
(43) Pub. Date: Jul. 9, 2009

(54) Container for engine lubricating oil

(76) Inventor: Gary R. Papas, Shrewsbury, PA (US)

Correspondence Address: RYAN KROMHOLZ & MANION, S.C., POST OFFICE BOX 26618, MILWAUKEE, WI, 53226, US

(21) Appl. No.: 12/008,219

(22) Filed: Jan. 9, 2008

(51) Int. Cl. B65D 25/28; F01M 1/12; F01M 11/02; F16L 15/00; F16L 37/00; F16L 23/00

(52) U.S. Cl. 184/6.13; 123/196 R; 285/33; 285/18; 220/752

(57) ABSTRACT

A removable oil storage tank for lubricating an engine. The oil storage tank includes a body having a reservoir, an oil inlet and an oil outlet. A pick up tube in connected to the oil outlet. Connectors are coupled to the oil inlet and oil outlet. Oil lines are coupled to the connectors to couple to oil inlet of the tank to the outlet of the engine and the oil outlet of the tank to the inlet of the engine.

### BACKGROUND OF THE INVENTION

The invention disclosed here in relates to an improved container for engine lubricating oil. There are two different types of lubrication systems, a wet sump and a dry sump. The standard engine lubrication system is a wet sump system. In a wet sump, the sump is permanently attached to the engine. An oil pan is located at the bottom forming the sump. Oil is pumped into the various components of the engine and is allowed to drain to the base of the engine, into the oil pan. From the oil pan the oil is pumped back up to the various components.

In a wet sump system, the integral nature of this type of system makes it more difficult to replace the oil in the system. Further, the high heat from the engine can cause the oil itself to deteriorate. At higher temperatures acids form more quickly. The oil in the wet sump system is continuously churned up by the crankshaft of the engine which can cause the oil to deteriorate more rapidly. This is because of the physical destruction of the polymers from hitting the speeding crankshaft.

In a dry sump system, the oil is stored in a separate tank or reservoir. Oil is still allowed to lubricate the system and drain to the base of the engine. However, rather than the oil collecting in an oil pan as in a wet sump system, the oil is pumped into the separate reservoir. Oil from the separate reservoir is then pumped to the bearings of the engine to lubricate the engine.

A single oil pump with multiple stages or multiple oil pumps may be used to return the oil from the engine to the separate reservoir.

In some cases a wet sump system is converted into a dry sump system. In this case, the original oil pump may be used to facilitate engine lubrication. The original oil pick-up may be removed and replaced with a suitable pipe or hose to connect the suction side of the pump with the separate reservoir. An additional oil pump is then fitted to the engine that is properly sized to extract all of the liquid oil from the original sump and a volume of air in the oil sump so as to produce a lower pressure in the oil sump. This lower pressure will insure that all liquid oil is removed and that the reduced pressure is available to help improve the sealing action of the piston rings.

The return oil pump may be 2 to 6 times the capacity of the lubricating oil pump so that the actual pressure produced in the oil sump can be adjusted to optimum by controlling the return pump speed. Optimum pressure will preferably be below the vapor pressure of the oil in the engine when it is at operating temperature. This may eliminate oil foaming in the suction lines of the return oil pump. The return oil pump may be mounted to the engine such that the pump may be driven from a rotating shaft normally found in the engine or protruding from the engine. Specialized mounting to accessory cover or other driven equipment is also possible, i.e. an oil pump driven from the rear of the alternator.

The standard oil circuit of the original lubricating oil pump may be modified so that excess oil produced by the pump is returned to the remote sump directly rather than recirculate to the intake side of the oil pump.

### SUMMARY OF THE INVENTION

The invention is a removable oil storage tank for use in lubricating an internal combustion engine. The oil tank may include a tank body having an inlet and an outlet with a reservoir beneath the outlet. The tank body being separate from the engine. The tank may include a plurality of oil lines for carrying oil between the oil tank and the engine. The tank may also include connectors for connecting each of the oil lines to the oil tank and to the engine.

The oil tank connectors may be quick disconnects, snap-on connectors, or screw on connectors.

The oil lines may include an oil inlet line connected to the tank inlet and an oil outlet line connected to the tank outlet.

The oil inlet line and oil outlet line may be flexible lines.

The tank may have a pick up tube coupled to the tank body outlet which extends into the reservoir.

The pick up tube may be a rigid tube.

The tank may include a handle coupled to said tank body.

In one embodiment, the oil tank may include a tank body having an aperture and a reservoir beneath the aperture. The tank body may be separate from the engine. The tank may include a plurality of oil lines for carrying oil between the oil tank and the engine. The tank may include connection means coupled to the tank body for connecting the plurality of oil lines to the oil tank and to the engine.

The connection means may be a flange having an inlet port and an outlet port.

The flange may be glued to the tank body. The flange may be bolted to the tank body.

The connection means may be inserted into the aperture in the tank body.

In one embodiment the tank may be connected to a generator including an engine and an enclosure. The tank may be located remote from the engine within the enclosure. The tank may be coupled to a wall of the enclosure.

The present invention includes a method including providing an engine, a first oil tank, a plurality of oil lines for carrying oil between the first oil tank and the engine, connectors for coupling the plurality of oil lines to the first oil tank, and an oil pump, wherein the first oil tank is not coupled to the engine. The method may further include providing a second oil tank. The method may further include replacing the first oil tank with the second oil tank.

The method may further include disconnecting the plurality of oil lines from the first oil tank and connecting the plurality of oil line to the second oil tank.

The method may further include the connectors being coupled to a flange and removing the flange from the first oil tank and the connecting step comprising coupling the flange to the second oil tank.

The method may further include gluing the flange to the second oil tank.

The method may further include bolting the flange to the second oil tank.

### BRIEF DESCRIPTION OF THE DRAWINGS

FIG. 1 is a perspective partially of an oil tank according to the present invention.

FIG. 2 is a simplified schematic of the oil tank of FIG. 1 coupled to a generator.

FIGS. 3A and 3B show an alternative embodiment of an oil tank according to the present invention, the oil tank having a connection flange which is shown in an exploded view and unexploded view respectively.

FIGS. 4A and 4B show an additional alternative embodiment of an oil tank according to the present invention, the oil tank having a connection flange and attachment ring which are shown in an exploded view and unexploded view respectively.

FIGS. 5A, 5B, and 5C show an additional alternative embodiment of an oil tank and cover according to the present invention.

FIGS. 6A and 6B show an additional alternative embodiment of an oil tank and cap according to the present invention.

FIGS. 7A and 7B show an additional alternative embodiment of an oil tank and connection flange according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

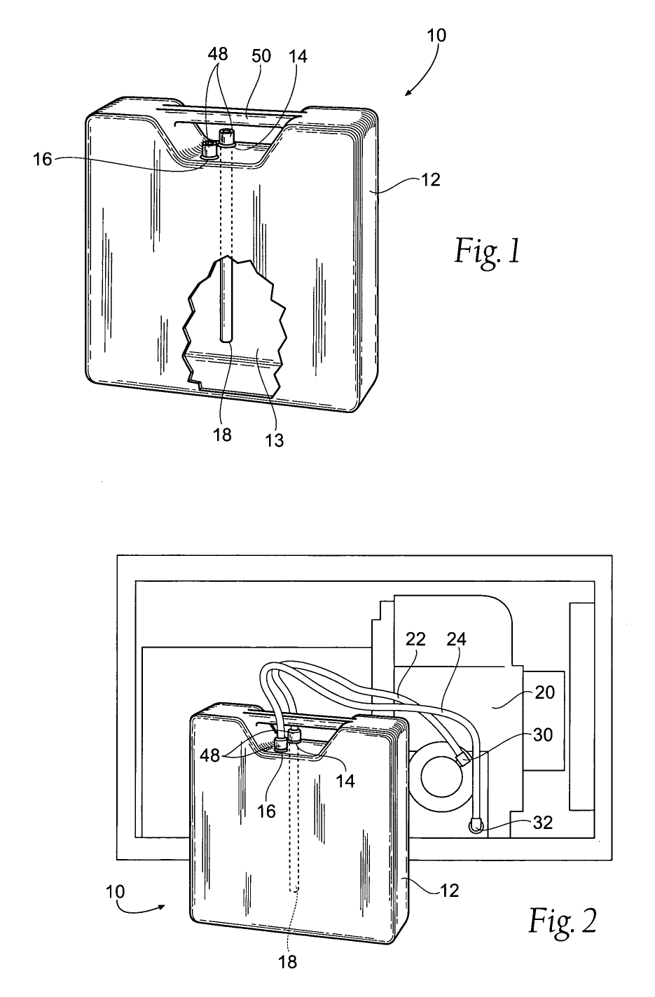

FIG. 1 shows a first embodiment of a lubricating oil tank 10 according to present invention. The oil tank 10 may be used in combination with an engine 20 as shown in FIG. 2. The oil tank 10 preferably comprises a body 12 forming a reservoir 13 for containing lubricating oil. In the illustrated embodiment, the body 12 is preferably generally rectangular; however it is contemplated that the body 12 could take virtually any shape. The oil tank body 12 preferably has two ports 14,16 on the top surface of the body 12. The first port is an outlet port 14 for oil exiting the tank 10 while the second port is an inlet port 16 for oil returning to the tank 10 from the engine 20.

Preferably, the first outlet port 14 has a pick-up tube 18 attached thereto which extends into the reservoir 13. The pick-up tube 18 desirably extends generally to the lower middle portion of the reservoir 13. As sediment in the oil settles to the bottom of the reservoir 13, it is desirable that the pick-up tube 18 not extend all the way to the bottom of the reservoir 13. In this manner, clean oil, without sediment is returned to the engine 20 to lubricate. Further, foam can form at the top of the reservoir 13 as oil is returned to the tank 10 from the engine 20. This foam generally sits at the top of the oil in the reservoir 13 and dissipates over time. For this reason it is desirable that the pick-up tube 18 be lower in the reservoir 13 so as to avoid sucking up the foam and distributing the foam to the engine 20. The pick-up tube 18 is preferably rigid to avoid collapse from the suction of an associated oil pump (not shown). If the pick-up tube 18 is a flexible line, the pick-up tube preferably has sufficient wall thickness to maintain the inner diameter of the tube 18 when the oil is cold and viscous.

FIG. 2 shows an engine 20 with an oil tank 10 according to the present invention. The oil tank 10 is preferably located away from and not attached to the engine 20. The preferred location of the oil tank 10 will be discussed in more detail below. The outlet port 16 of the oil tank 10 is preferably coupled to the oil inlet 30 of the engine 20 by an outlet oil line 24. The inlet port 14 of the oil tank 10 is preferably coupled to the outlet 32 of the engine 20 by an inlet oil line 22. The oil lines 22,24 are preferably connected to the inlet 14 and outlet 16 ports of the oil tank 10 and the inlet 30 and outlet 32 of the engine 20 by standard connectors.

The inlet oil line 22 and outlet oil line 24 connecting the oil tank 10 to the engine 20 make take any form known to those of skill in the art, including, but not limited to flexible tubing and rigid pipe. In the preferred embodiment, the inlet and outlet oil lines 22,24 comprise flexible tubing, such that the oil tank 10 may be movable relative to a engine 20 within a generator cabinet (not shown) as described below. Flexible tubing also allows for ease of installation and changing of the oil tank 10 because the connectors between the oil tank 10 and the engine 20 to be easily removed.

In a situation in which rigid piping is used, the oil tank 10 would need to be located above the floor of a generator cabinet (not shown) so that when the tank 10 is disconnected, the oil tank 10 can be pulled free of the connections.

It is desirable to reduce the complexity of changing the oil in the system to reduce the costs associated with maintenance of the engine 20. The present invention decreases the amount of time needed to change the oil in the generator system 20. The steps to change the oil in the system using the preferred embodiment of the oil tank 10 include providing a new oil tank 10. The new oil tank 10 is similar in configuration to the existing oil tank 10, but is filled with new clean oil and the connections 48 are covered with caps (not shown). The oil lines 22,24 are then detached from the existing oil tank 10 and the oil tank 10 is removed from the generator cabinet (not shown). The cap is removed from the new oil tank 10. The new oil tank 10 is placed in the generator cabinet (not shown) and the oil lines 22,24 are attached to the connections 48 on the new tank 10.

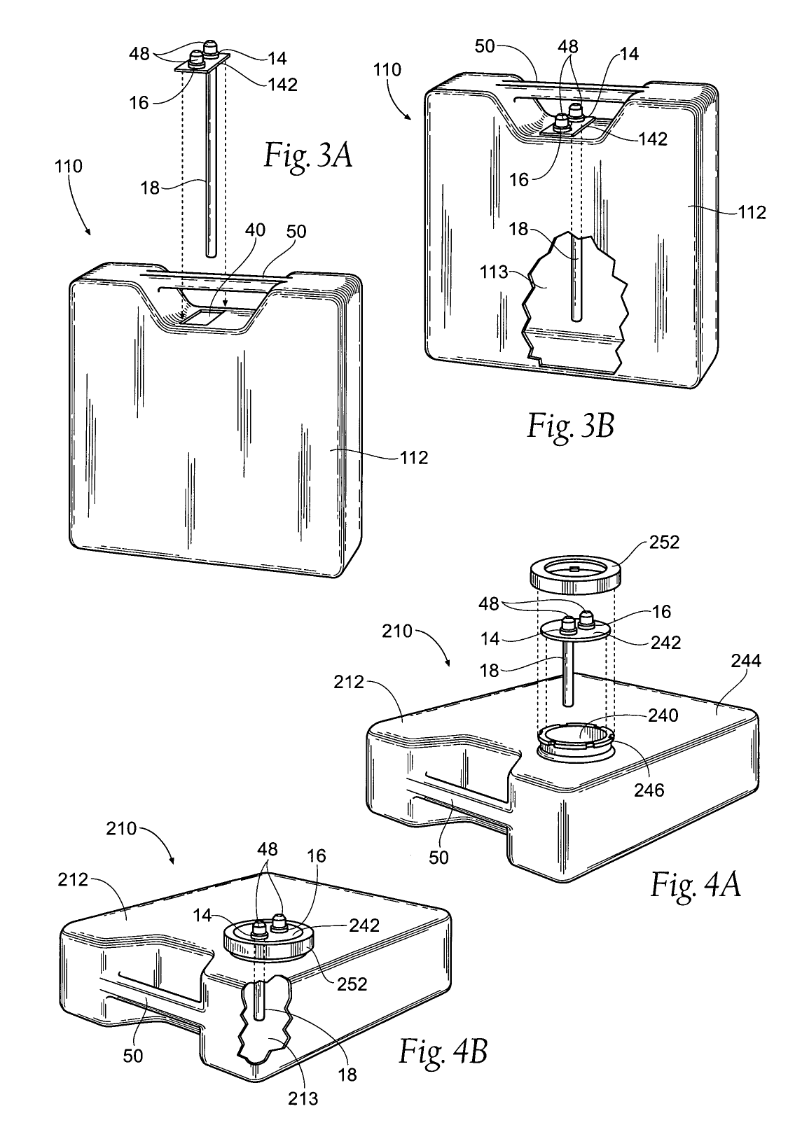

In an alternative embodiment as shown in FIGS. 3A and 3B, the oil tank body 112 is generally the same as described above. However, the outlet 14 and inlet 16 port are not formed in the top surface of the tank body 112. Rather, an aperture 40 is formed in the top surface of the tank body 112 and a connection flange 142 is attached to the top surface of the tank body 112. The connection flange 142 preferably includes an outlet port 14 and an inlet port 16. Preferably standard connectors 46 are coupled to each of the ports 14,16 and a pick up tube 18 is coupled to the outlet port 14. The connection flange 142 may be attached using any known means. It is contemplated that the flange 242 and oil tank body 112 could be magnetically attached. It is further contemplated that the flange 142 could be attached to the oil tank body 112 by epoxy or glue.

In use, the connection flange will be removed from the oil tank body 112 and placed on a new oil tank body 112 containing clean oil in order to change the oil in the generator system.

In an alternative embodiment as shown in FIGS. 4A and 4B, it is also contemplated that the oil tank 210 may be placed on its side. The oil tank 210 preferably comprises a body 212 forming a reservoir 213 for containing oil. In the illustrated embodiment, the body 212 is preferably generally rectangular; however it is contemplated that the body 212 could take virtually any shape. In this configuration, the body 212 may be formed with an aperture 240 in one of the side surfaces 244. The aperture 240 is preferably generally circular. In the illustrated embodiment, the aperture 240 is formed with an upstanding connection member 246 formed around the circumference of the aperture 240 and extending outward form the side surface 244 of the tank body 212.

A connection flange 242 may then be connected to the oil tank body 212 to connect the hoses (not shown) from the engine (not shown) to the oil tank 212 as generally described above. The connection flange 242 preferably includes an outlet port 14 and an inlet port 16. The connection flange 242 may also include a connector 48 coupled to each of the inlet 16 and outlet 14 ports. It is further contemplated that a pickup tube 18 may be coupled to the outlet port 14 and adapted to extend into the reservoir 213.

The connection flange 242 may be attached using any known means. It is contemplated that the flange 242 and oil tank body 212 could be magnetically attached. It is further contemplated that the flange 242 could be attached to the oil tank body 212 by epoxy. It is further contemplated that an upstanding connection member 246 may be formed on the surface of the tank body 212 as described above. As shown in FIGS. 4A and 4B, the flange 242 could be held in place by attaching a ring 252 to the upstanding connection member 246, similar to a canning jar.

It is contemplated that in an alternative embodiment, any standard oil container, including but not limited to a five-gallon pail, could be utilized in the system of the invention. In such a situation, the user would not have to purchase a special type of oil container. Rather, the user could purchase any oil container and attach the standard oil container to the system.

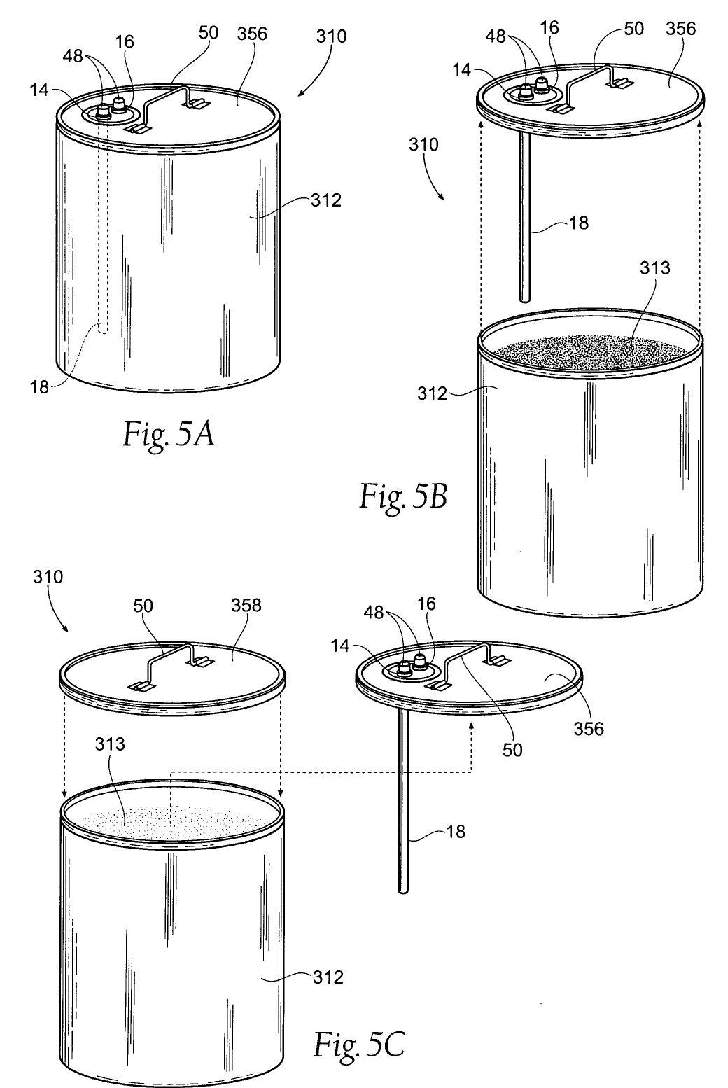

In an embodiment shown in FIGS. 5A to 5C, the oil tank 310 comprises a standard oil container with a removable top 358. A replacement top 356 preferably includes an outlet port 14 and an inlet port 16. The replacement top 356 may also include a connector 48 coupled to each of the inlet 16 and outlet 14 ports. It is further contemplated that a pickup tube 18 may be coupled to the outlet port 14 and adapted to extend into the reservoir 313. It is contemplated that the oil lines (not shown) could be already attached to the replacement top 356 or that the oil lines (not shown) could be connected to the replacement top 356 after installing the replacement top 356 to the oil tank body 312.

In order to replace the oil in the system, a new standard oil tank 310 is provided. The standard top 358 is removed from the new oil tank body 312 and the replacement top 356 is removed from the used oil tank body 312. The standard top 358 is then placed on the used oil tank body 312 to seal the tank body 312 for disposal. The replacement top 356 is placed on the new oil tank body 312. In this manner, the replacement top 356 may be reused on standard oil tanks bodies 312 to achieve simple replacement of the oil in the system.

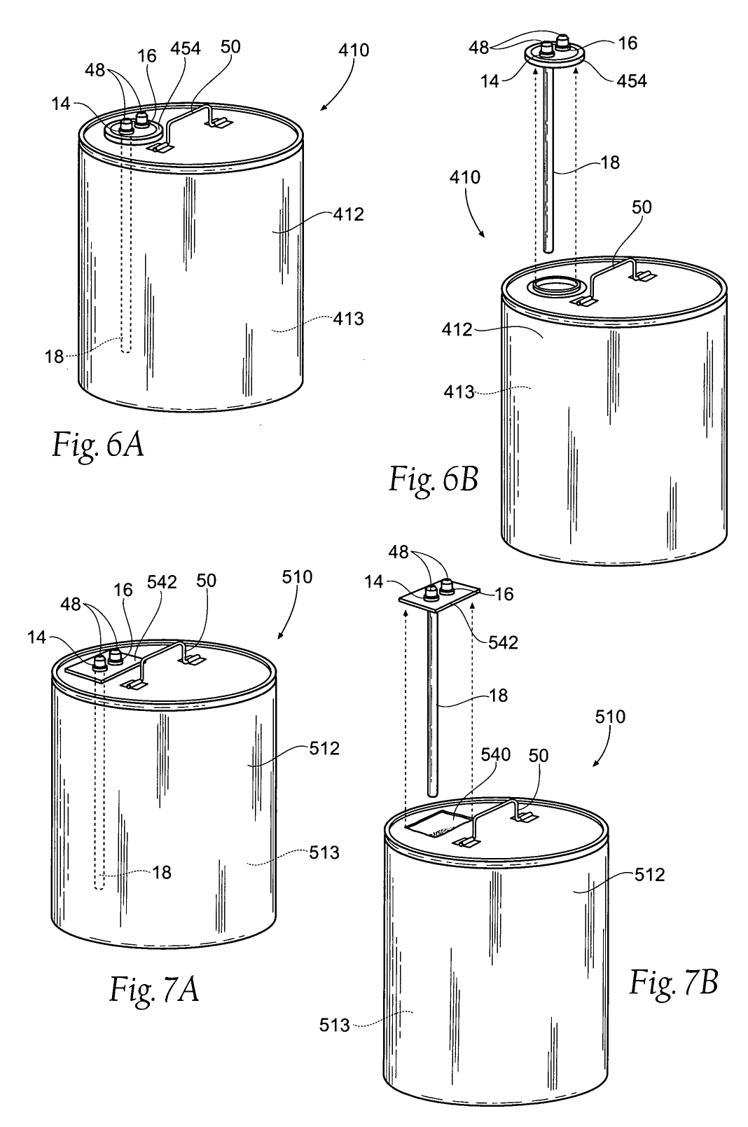

As shown in FIGS. 6A and 6B, a replacement cap 454 or bung could be used to replace the standard oil tank cap or bung on an oil tank 410. The replacement cap 454 preferably includes an outlet port 14 and an inlet port 16. The replacement cap 454 may also include a connector 48 coupled to each of the inlet 16 and outlet 14 ports. Preferably connectors 48 are coupled to both the outlet 14 and inlet 16 ports for connecting oil lines (not shown) from the generator (not shown) to the oil tank 210. After purchasing a standard oil tank the user would remove the standard cap and replace the standard cap with a replacement cap 454. It is contemplated that the oil lines (not shown) could be already attached to the replacement cap 454 or that the oil lines (not shown) could be connected to the replacement cap 454 after installing the replacement cap 454 to the oil tank 410.

In order to replace the oil in the system, a new standard oil tank is provided. The standard cap is removed from the new oil tank and the replacement cap 454 is removed from the used oil tank 410. The standard cap is then placed on the used oil tank 410 to seal the tank for disposal. The replacement cap 454 is placed on the new oil tank 410. In this manner, the replacement cap 254 may be reused on standard oil tanks to achieve simple replacement of the oil in the system.

In an embodiment shown in FIGS. 7A and 7B, the oil tank 510 comprises a standard oil container. It is also contemplated that a connection flange 542 may be provided for attachment to the oil tank body 512. The connection flange 542 preferably includes an outlet port 14 and an inlet port 16. The connection flange 542 may also include a connector 48 coupled to each of the inlet 16 and outlet 14 ports. It is further contemplated that a pickup tube 18 may be coupled to the outlet port 14 and adapted to extend into the reservoir 513. The flange 542 may also include the oil lines (not shown) described above for connecting the oil tank 510 to the engine.

To attach the connection flange 542 to the tank body 512, an aperture 540 is formed in the top of the standard oil tank body 512. The aperture 540 is sized and configured to accommodate the flange. In a preferred embodiment the aperture is a generally 2 inch by 3 inch rectangle. The flange 542 is then coupled to the standard oil tank body 512 at the aperture 540. The flange 542 may be fastened to the tank body 512 using any means known in the art, including, but not limited to bolts and/or epoxy. It is contemplated that if the flange 542 is to be bolted to the standard oil tank body 512 it may be desirable to utilize a gasket.

It is contemplated and may be desirable that the oil tank 10,110,210,310,410,510 be located in a compartment that is separate from the engine 20 and/or other sources of heat. It is further contemplated that it may be desirable to provide a heat shield (not shown) to separate the oil tank 10,110,210,310,410,510 from the engine 20 and/or other sources of heat.

The oil tank 10,110,210,310,410,510 can be made of any material commonly used in the lubrication arts, including, but not limited to plastic including but not limited to polypropylene, polyetherimide(PEI), PTFE, noryl, modified polyphenylene oxide(PPO), neoprene rubber, molded composition, or sheet metal provided that the material can withstand the high oil operating temperature. In the preferred embodiment the oil tank 10,110,210,310,410,510 is made of a metal material.

It may be desirable to increase the amount of lubricating oil that is available to the engine 20 in order to increase the interval between maintenance of the engine 20. Because the oil tank 10,110,210,310,410,510 of the present invention is not a component within the engine 20 the oil tank 10,110,210,310,410,510 can be larger than in a standard generator. The oil tank 10,110,210,310,410,510 of the preferred embodiment is sized to fit the generator compartment (not shown) and size of engine 20. In some cases it may be desirable to maximize the capacity of the oil tank 10,110,210,310,410,510 in order to increase the time period between oil changes. It will be clear to one of skill in the art that the oil tank 10,110,210,310,410,510 may be of any size that based on the minimum oil requirements of the engine and the size constraints of the generator cabinet.

It should be appreciated that while the preferred embodiments include a handle 50 to aid in the convenience of transporting and exchanging the oil tank 10, 110, 210, 310, 410, 510, the oil tank 10, 110, 210, 310, 410, 510 need not include a handle 50.

The connectors 48 may be of any type typically used in the lubricating art. Preferably the connectors 48 allow the oil lines to be removed from the oil tank 10,110,210,310,410,510. The types of connectors that may be used include, but are not limited to quick disconnects, push on connectors, or screw on connectors.

To increase the maintenance interval, it is desirable to limit the exposure of the oil to heat. An advantage of this invention is that the oil tank 10,110,210,310,410,510 does not need to be attached to the engine or engine 20. Because the oil tank 10,110,210,310,410,510 of the present invention is not physically attached to the engine 20, the oil tank 10,110,210,310,410,510 can be located remote from the engine 20, which will lower the temperature of the oil and allow for a longer oil life. In the preferred embodiment, the oil tank 10,110,210,310,410,510 simply sits on the floor of the generator cabinet (not shown), and can be placed in any convenient location within the cabinet. The oil tank 10,110,210,310,410,510 can be moved to allow access to the engine 20. The oil tank 10,110,210,310,410,510 would preferably be placed in the generator cabinet (not shown), but remote from the engine 20, so as to reduce the effect of the heat from the engine 20 on the oil in the oil tank 10,110,210,310,410,510.

In the preferred embodiment, the oil tank 10,110,210,310,410,510 is located in the generator cabinet, remote from the engine 20. Because the oil tank 10,110,210,310,410,510 is not attached to the engine 20, there is little motion imparted to the oil tank 10,110,210,310,410,510, and therefore the oil tank 10,110,210,310,410,510 is not required to be secured. The oil tank 10,110,210,310,410,510 can simply be set in any location within the generator cabinet. It is also contemplated that the oil tank 10,110,210,310,410,510 could be attached to a wall of the generator cabinet. It is also contemplated that the oil tank 10,110,210,310,410,510 could be secured to the engine 20 itself.

An advantage of this invention is that when the oil is changed, the entire tank body 12,112,212,312,412,512 is removed from the system, and a new oil tank body is replaced into the system. In this manner, oil does not need to be transferred from the shipping container to the oil tank of the system. This reduces the complexity of changing the oil in the system, thereby reducing costs. Eliminating the transfer of oil from the shipping container to a standard oil tank also reduces the possibility of spillage.

Further, the destructive sediments that normally accumulate in an engine oil pan now accumulate in the bottom of the tank body 12,113,212,312,412,512. When the used oil tank is removed from the system and replaced by a fresh or new oil tank the sediment is removed from the system along with the used oil tank.

It should be understood that this invention could be practiced in any situation where it is desirable to have a lubricating oil tank 10,110,210,310,410,510 remote from the engine, such as in an automobile, or other vehicle, etc. Due to the motion of a moving vehicle, the oil tank 10,110,210,310,410,510 would need to be attached to the vehicle. However, the oil tank 10,110,210,310,410,510 could still be of a larger size than normally used and remote from the engine in order to protect the integrity of the oil and increase the time interval between oil changes.

It should be understood that this invention may be practiced in any type of engine where lubrication is desired and further in any system where lubricating oil is desired. The oil tank of the present invention may be used in applications such as, but not limited to, pumps, fans, blowers, and compressors.

It is further contemplated that in some circumstances it may be desirable for one party, such as the engine supplier, to have control over the lubricant used in the engine. For example, the returned oil may include valuable information regarding the condition of the engine. In such a circumstance, the oil tank 10,110,210,310,410,510 may have a specific shape or fit within the equipment. This shape or configuration may be designed to be a non-standard size such that a new oil tank 10,110,210,310,410,510 must acquired from the manufacturer or its supplier. In such a case, used oil tanks 10,110,210,310,410,510 may be returned to the manufacturer, or a supplier for the manufacturer. The manufacturer or its supplier may then clean and refill the tanks for future use. If desired, the manufacturer may inspect the used oil in order to assess the condition of the engine.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. An oil tank for use with an internal combustion engine comprising:
a tank body, said tank body having an inlet and an outlet and a reservoir beneath the outlet, said tank body being separate from the engine;
a plurality of oil lines for carrying oil between the oil tank and the engine;
connector means for connecting each of the plurality of oil lines to the oil tank and to the engine.

2. The oil tank of claim 1 wherein said connector means comprise quick disconnects.

3. The oil tank of claim 1 wherein said connector means comprise snap-connectors.

4. The oil tank of claim 1 wherein said connector means comprise screw-on connectors.

5. The oil tank of claim 1 wherein said plurality of oil lines further comprise an inlet oil line connected to the tank body inlet and an outlet oil line connected to the tank body outlet.

6. The oil tank of claim 5 wherein said oil inlet line and oil outlet line are flexible lines.

7. The oil tank of claim 5 wherein a pick up tube is coupled to the tank body outlet and extends into the reservoir.

8. The oil tank of claim 7 wherein said pick up tube is a rigid tube.

9. The oil tank of claim 1 further comprising a handle coupled to said tank body.

10. An oil tank for use with an internal combustion engine comprising
a tank body, said tank body having an aperture and a reservoir beneath the aperture, said tank body being separate from the engine;
a plurality of oil lines for carrying oil between the oil tank and the engine;
connection means for connecting the plurality of oil lines to the oil tank and to the engine, said connection means being coupled to the tank body.

11. The oil tank of claim 10 wherein the connection means comprises a flange, the flange having an inlet port and an outlet port.

12. The oil tank of claim 11 wherein the flange is glued to the tank body.

13. The oil tank of claim 11 wherein the flange is bolted to the tank body.

14. The oil tank of claim 10 wherein the connections means are inserted into the aperture in the tank body.

15. An oil tank apparatus for use in a generator, the generator including an enclosure and an internal combustion engine within the enclosure, the engine including an oil inlet and an oil outlet, the apparatus comprising:
a tank body, said tank body having an inlet and an outlet and a reservoir beneath the outlet;
a plurality of oil lines for carrying oil between the oil tank and the engine;
connector means for connecting each of the plurality of oil lines to the oil tank and to the engine.

16. The apparatus of claim 15 wherein the tank body is located remote to engine, but with the enclosure

17. The apparatus of claim 15 wherein the tank body is located on a wall of the enclosure

18. A method comprising:
providing a generator including an engine, a first oil tank, a plurality of oil lines for carrying oil between the first oil tank and the engine, connectors for coupling the plurality of oil lines to the first oil tank, and an oil pump, wherein said first oil tank is not coupled to said engine;
providing a second oil tank;
replacing said first oil tank with said second oil tank.

19. The method of claim 18 wherein said replacing step further comprises
disconnecting the plurality of oil lines from the first oil tank; and
connecting the plurality of oil line to the second oil tank.

20. The method of claim 19 wherein said connectors are coupled to a flange;
the disconnecting step further comprising removing the flange from the first oil tank; and
the connecting step comprising coupling the flange to the second oil tank.

21. The method of claim 20 wherein said connecting step further comprises gluing the flange to the second oil tank.

22. The method of claim 20 wherein said connecting step further comprises bolting the flange to the second oil tank.
